(19) United States
(12) Patent Application Publication
(10) Pub. No.: US 2006/0264286 A1
(43) Pub. Date: Nov. 23, 2006

(54) Sprocket

(76) Inventor: Yahya Hodjat, Oxford, MI (US)

Correspondence Address: Jeffrey Thurnau;The Gates Corporation, MS: IP Law Dept. 10-A3, 1551 Wewatta Street, Denver, CO, 80202, US

(21) Appl. No.: 11/133,927

(22) Filed: May 20, 2005

(51) Int. Cl. F16G 13/02; F16H 55/30

(52) U.S. Cl. 474/152

(57) ABSTRACT

A sprocket comprising a cast wheel (10) having a rim (12), the rim having a toothed profile (15), a ring (20) having a thickness and toothed profile (21) that substantially matches the rim toothed profile, the ring having a press fit to the rim, and the ring comprising a metallic material having a hardness greater than a hardness of the cast wheel.

### FIELD OF THE INVENTION

The invention relates to a sprocket, namely, a cast sprocket having a wear resistant metallic jacket.

### BACKGROUND OF THE INVENTION

Sprockets are used in power transmission systems together with toothed belts. One of the most common applications is motorcycle drive systems. The sprocket for rear wheel drive of a motorcycle is usually in a range of 10 to 15 inches in diameter. These sprockets have to transfer the power, resist wear, resist corrosion, and be cosmetically acceptable as they are in an exposed part of the motorcycle.

These sprockets are either cast aluminum with hard chrome plated grooves (to resist wear), or formed and painted sheet steel sprockets. The chrome plating layer on aluminum sprockets has a relatively short life. The chrome plating layer usually wears or chips out. After the chrome plating is lost the underlying aluminum wears very rapidly.

The chrome plating has to be very accurately applied in order to keep the proper dimensions of the teeth and grooves to the required tight tolerances. Failure of any of the tolerances will accelerate belt and sprocket wear, an undesirable outcome. Chrome plating is also a very expensive process.

Sheet steel sprockets are not commonly used for motorcycle drive sprockets because they cannot have the cosmetic features of a cast part. This is because sheet metal sprockets are flat on the face while castings can have three dimensional designs. They also rust as the belt wears the paint in the tooth area exposing the sheet steel to the environment.

Representative of the art is U.S. Pat. No. 5,098,346 to Redmond (1992) which discloses a toothed sprocket with rim portion made of a first composite material of discontinuous fiber disposed in a plastic matrix and where the teeth of the rim portion are covered with an encircling layer of a second composite material that includes a fibrous material and an elastomeric matrix and fibers embedded in the matrix.

What is needed is a cast sprocket having a wear resistant metallic jacket. The present invention meets this need.

### SUMMARY OF THE INVENTION

The primary aspect of the invention is to provide a cast sprocket having a wear resistant metallic jacket.

Other aspects of the invention will be pointed out or made obvious by the following description of the invention and the accompanying drawings.

The invention comprises a sprocket comprising a cast wheel having a rim, the rim having a toothed profile, a ring having a thickness and toothed profile that substantially matches the rim toothed profile, the ring having a press fit to the rim, and the ring comprising a metallic material having a hardness greater than a hardness of the cast wheel.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a right side view of the inventive sprocket.

FIG. 2 is a left side view of the inventive sprocket.

FIG. 3 is a detail of FIG. 1.

FIG. 4 is a cross-section of an ironing die tool and wheel.

FIG. 5 is a plan view of an ironing die.

### DETAILED DESCRIPTION OF THE PREFERRED EMBODIMENT

The invention comprises a jacketed sprocket. The sprocket comprises an inner wheel with an outer ring shaped jacket mounted to a wheel rim. The wheel comprises a relatively inexpensive and soft material such as cast aluminum, cast magnesium, phenolic resin, urethane, or any other suitable material capable of bearing the operational torque loads. A die casting aluminum alloy that can be used for the inventive sprocket is 380, ASTM designation SC84A. Also suitable are 384 and 390 alloys. The hardness of the casting is in the range of approximately 25 Rockwell B to 55 Rockwell B.

The outer ring comprises a metallic material of sufficient hardness to withstand wear caused by a belt engaged with the toothed surface. The outer ring has a hardness greater than the hardness of the wheel, namely, greater than approximately 55 Rockwell B.

The inventive sprocket can be used on various applications, including motorcycle belt drives, golf cart and ATV drives to name but a few. The inventive sprocket may be used on any service which requires a light and inexpensive material of suitable strength to bear applied torque loads and having a wear resistant belt bearing surface for operational longevity.

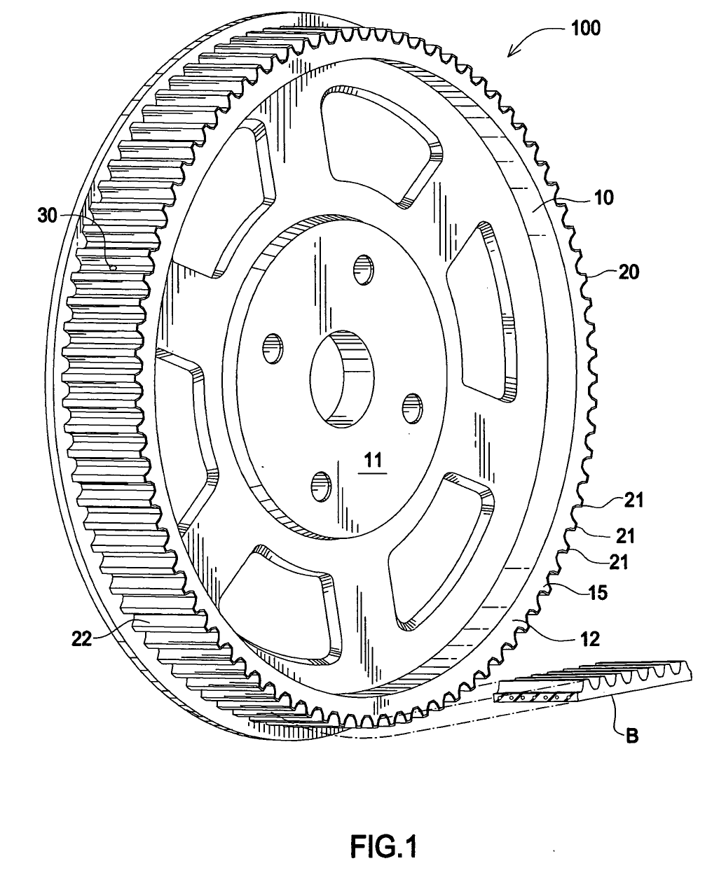

FIG. 1 is a right side view of the inventive sprocket. Sprocket 100 comprises wheel 10. Wheel 10 comprises hub 11 and rim 12. Rim 12 comprises teeth 15. Rim 12 may comprise any desired profile including flat or ribbed as known in the art. Teeth 15 are not offered by way of limitation. The profile of teeth 15 may comprise any known in the art, including that disclosed in U.S. Pat. No. 4,605,389, incorporated herein in its entirety by reference.

Ring 20 is engaged with rim 12. Ring 20, which can be characterized as a jacket, comprises teeth 21 to form a toothed profile that substantially matches teeth 15 on rim 12. Ring 20 also comprises a belt engaging surface 22. Ring 20 has a hardness greater than the hardness of the wheel 10 to resist wear.

Sprocket 100 engages an endless drive member such as a toothed belt B in a power transmission system. Such a power transmission system can include, but is not limited to a motorcycle secondary drive (not shown) which comprises a transmission sprocket and a wheel sprocket. Surface 22 of ring 20 engages belt B.

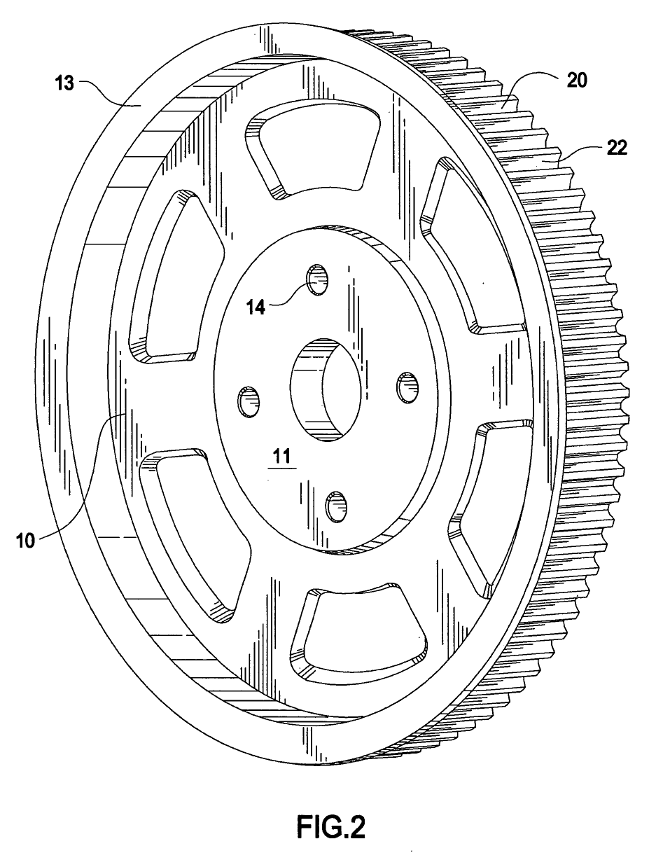

FIG. 2 is a left side view of the inventive sprocket. Wheel 10 comprises a flange 13 which extends to a radius greater than the radius of ring 20. This allows flange 13 to keep a belt (not shown) properly engaged with ring 20 by controlling lateral movement. The inventive sprocket may comprise two such flanges, namely, one on each side of rim 12.

Ring 20 comprises an accurately formed stainless steel jacket having substantially the same shape as the sprocket teeth 15. Ring 20 is in the range of approximately 0.5 mm to 3 mm thick.

Wheel 10 comprises a hub 11 for mounting the sprocket to a shaft (not shown). Holes 14 receive fasteners such as bolts (not shown) for mounting hub 11 to a shaft or to a motorcycle wheel hub (not shown).

Following are two example methods of manufacturing the sprocket are offered by way of example and not by way of limitation.

Manufacturing Process One:

a. Wheel 10 is manufactured by die casting aluminum using methods known in the art. Wheel 10 has a finished rim outer surface 150 dimension that is about 0.5 mm to 3 mm smaller than the final product diameter D1 measured to surface 22 when ring 20 is in place on wheel 10. The allowance for the final product diameter is meant to accommodate system design parameters that include the diameter of the sprocket at the surface where the belt engages the sprocket, namely, surface 22. Of course, if the final product diameter is not a constraint, then the thickness of the ring 20 need not be compensated for during manufacture of the wheel. The hardness range for the aluminum wheel is Rockwell B (equivalent) of approximately 25 to 55. In an alternate embodiment, wheel 10 may be formed by machining billet material.

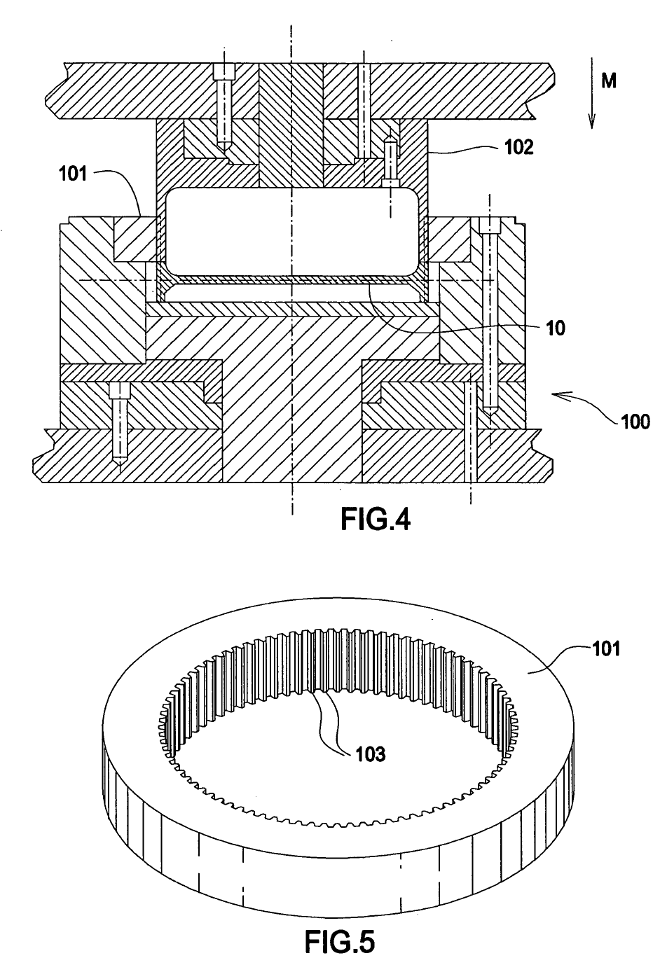

b. Wheel 10 is sized or ironed in an ironing die in a manner known in the art. FIG. 4 is a cross-section of an ironing die tool. The ironing die 100 is used to size outer surface 150 of wheel 10 to a very accurate size. The ironing die may comprise one or more sections 101, for example five sections, that are stacked one on top of the other. Wheel 10 is first die cast as described above, including teeth 15 and grooves 16, to a dimension that substantially fits the first ironing die. In subsequent die sections, the metal in the outer toothed area of the wheel is forced by ram 102 in direction M through the very precisely dimensioned ironing die sections, each step about 0.025 mm (0.001″) smaller than the previous step. FIG. 5 is a plan view of an ironing die. Ironing die 101 comprises a profile 103 which irons the toothed profile in wheel 10. The end result is a dimensionally precise outer surface 150 and tooth shape for the finished wheel 10. The ironing steps are performed to significantly reduce or eliminate any dimensional inaccuracy in the cast wheel dimensions. Wheel 10 then ends up with a precise outer toothed profile as shown in FIG. 1.

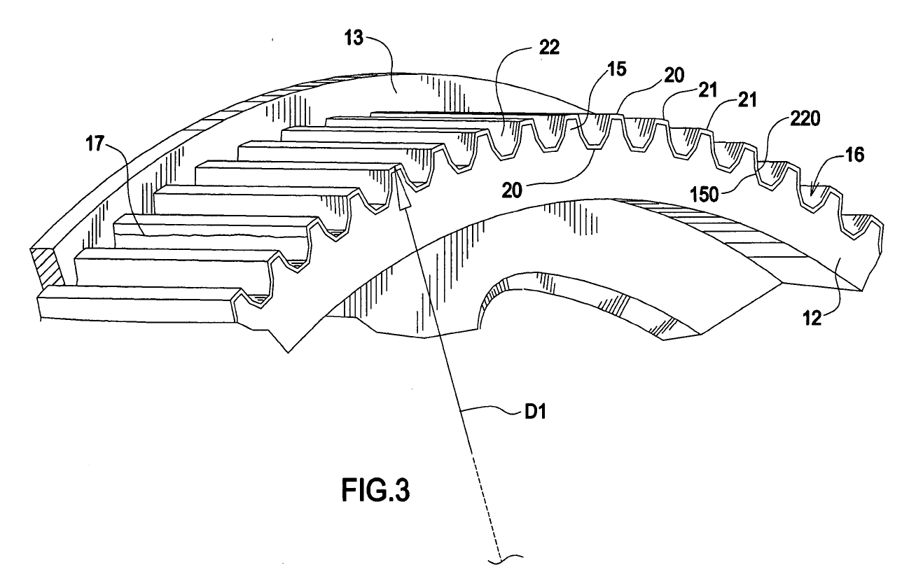

c. Ring 20 is made of stainless steel (or other steels such as low carbon steel, high carbon steel, or alloy steels and also non-ferrous metals). Ring 20 is formed from an approximately 0.5 mm to 3 mm thick strip, the ends of which are welded together to form a ring. Weld 17 is shown on FIG. 3. The strip has a width that is approximately the same as the width of rim 12. Rim 12 has a width to cooperatively match with the belt to be used on the sprocket, for example, approximately 20 mm to 25 mm wide, although the dimension is variable according to the width of the belt used. Ring 20 has a shape to substantially match wheel teeth 15. The jacket 20 can be formed by methods known in the art including but not limited to rolling, spinning, hydroforming, or press forming. The jacket may also be made by roll forming a coil of steel to a corrugated shape and then cutting strips of it to the desired width followed by creating a ring and welding the ends of the ring. Press forming is generally the least expensive and preferred option. The hardness range for the stainless steel ring is from a Rockwell B of approximately 90 (which is equivalent of Rockwell C of 9). The ring 20 can be case hardened up to Rockwell C of approximately 62 if necessary for sever service conditions, for example, high dust or debris loading.

d. Ring 20 is placed in a tool having a form matching ring 20 which restricts movement of the ring radially outward, that is, it prevents ring 20 from expanding as wheel 10 is press fit into ring 20. The tool has a profile dimensionally matching the final profile of the finished sprocket. Wheel 10 is press fit into ring 20.

e. A number of mechanical locking methods can be used to prevent any lateral, circumferential or radial movement of the ring on the wheel. This can be, but is not limited to tabs, grooves, flanges, staking, lancing, peening in addition to any other suitable equivalents thereof. For example, flange 13 prevents lateral movement of ring 20. A peening or staking dimple 30 is shown in FIG. 1.

Manufacturing Process Two:

In this process, ring 20 is made as described above. Ring 20 is then placed in an aluminum die casting over-mold, whereby wheel 10, and flange 13 if so desired, are over-molded to ring 20. This method has fewer steps than the first and can create a better bond between wheel 10 and ring 20. A flange or flanges can be simultaneously cast around the toothed ring. The aluminum alloy chosen for over-molding has to have little or no shrinkage from liquid to solid state. Such alloys are known in the art, including those listed previously in this specification. In addition to standard die casting practice for over molding, semi-solid high pressure molding of aluminum, also known in the art, can be used.

However, since aluminum alloys may shrink about 7% during solidification, normal over-molding may not be optimal since this is a larger contraction for the aluminum core as compared to the stainless steel ring 20. Consequently, for the over-molded option the core wheel 10 is designed for aluminum in a way that can easily be pressed or forged to compensate for the shrinkage. For instance, a slight dome shape can be made at the hub 11 that after solidification is pushed inwards, that is in an axial direction to ‘flatten’ the dome, thereby forcing the rim portion 12 outward to compensate for the casting shrinkage.

An alternate method comprises use of a non-shrinking material for the core of the over-molded wheel 10 such as glass fiber and mineral filled phenolic resin. Such materials are strong enough to handle the application load and will not chip nor shrink. Glass fibers give phenolic resins strength and chip resistance and mineral fillers give them dimensional stability. Some of the other alternative materials for the wheel 10 are other thermoset resins, magnesium, and thermoplastic resins.

The advantages of this invention are a sprocket that is light and wear resistant. The inventive sprocket is less costly to manufacture than existing art. A flange or flanges can be added to the sprocket without significant additional cost. The inventive sprocket also allows any desired cosmetic design to be easily cast into the wheel, while creating a very accurate, strong, and wear resistant tooth and groove area. Finally, the inventive sprocket is corrosion resistant and does not require painting or other corrosion resistant finish.

FIG. 3 is a detail of FIG. 1. Teeth 15 on rim 12 comprise an outer surface 150. Outer surface 150 engages surface 220 on ring 20. Grooves 16 are disposed adjacent teeth 15. The ends of ring 20 are welded together at weld 17.

Although forms of the invention have been described herein, it will be obvious to those skilled in the art that variations may be made in the construction and relation of parts without departing from the spirit and scope of the invention described herein.

I claim:

1. A sprocket for engaging an endless drive member comprising:
a cast wheel having a rim;
the rim having a toothed profile;
a ring having a thickness and a toothed profile that substantially matches the rim toothed profile, the ring having a press fit to the rim;
the ring comprising a metallic material having a hardness greater than a hardness of the cast wheel; and
the ring having a surface for engaging the endless drive member.

2. The sprocket as in claim 1, wherein the cast wheel comprises aluminum.

3. The sprocket as in claim 1, wherein the ring comprises steel.

4. The sprocket as in claim 1, wherein the cast wheel comprises a hub for mounting the wheel to a shaft.

5. The sprocket as in claim 1, wherein the ring comprises a strip having ends joined together.

6. The sprocket as in claim 1, wherein the thickness is in the range of approximately 0.5 mm to approximately 3 mm.

7. A method of manufacturing a sprocket comprising:
casting a wheel having a toothed profile;
ironing the wheel to adjust the toothed profile dimensions;
forming a metallic ring having a toothed profile;
restricting the metallic ring to prevent an outward expansion of the metallic ring; and
pressing the wheel into the metallic ring.

8. The method as in claim 7, wherein forming the metallic ring comprises welding the ends of a strip of steel together to form the metallic ring.

9. The method as in claim 7 further comprising:
forming the metallic ring using a material having a thickness in the range of approximately 0.5 mm to approximately 3.0 mm; and
the metallic ring having a hardness greater than a hardness of the wheel.

10. The method as in claim 7, wherein forming a metallic ring having a toothed profile further comprises press forming.

11. A method of manufacturing a sprocket comprising:
forming a metallic ring having a toothed profile;
placing the ring in a die casting mold; and
casting a wheel within the ring.

12. The method as in claim 11, wherein forming a metallic ring having a toothed profile further comprises welding the ends of a strip of stainless steel together to form a ring.

13. The method as in claim 11 further comprising forming the metallic ring using a material having a thickness in the range of approximately 0.5 mm to approximately 3.0 mm and the metallic ring having a hardness greater than a hardness of the wheel.
